(19) United States
(12) Patent Application Publication
(10) Pub. No.: US 2010/0164668 A1
(43) Pub. Date: Jul. 1, 2010

(54) Reactor Core

(75) Inventor: Agne Fälldin, Sundsvall (SE)

Correspondence Address: POTOMAC PATENT GROUP PLLC, P. O. BOX 270, FREDERICKSBURG, VA, 22404, US

(73) Assignee: Hexaformer AB, Upplands Vasby (SE)

(21) Appl. No.: 12/527,457

(22) PCT Filed: Feb. 20, 2008
(86) PCT No.: PCT/SE2008/000138

§ 371 Date: Feb. 18, 2010

(30) Foreign Application Priority Data
Feb. 20, 2007 (SE) 0700409-6

(51) Int. Cl. H01F 17/06

(52) U.S. Cl. 336/178

(57) ABSTRACT

A reactor core is formed in an essentially triangular shape. Such a reactor core shape can advantageously be obtained by winding a strip of electromagnetic material, such as a strip of transformer plate, a number of windings into a triangular shape.

### TECHNICAL FIELD

The present invention relates to a reactor and a reactor core for generating reactive power.

### BACKGROUND

A reactor is an electrical device used for generating reactive power. Reactors are used in many different environments and for many different purposes. One application for a reactor is as a grounding reactor, used in alternating-current power transmission systems. It can then be designed and used to limit the current flowing to ground at the location of a fault almost to zero by setting up a reactive current to ground that balances the capacitive current to ground flowing from the electrical transmission power lines. Such an arrangement is also known as a Petersen coil.

Reactors in used in power transmission systems are heavy and they are also cumbersome to manufacture. The manufacturing process of a conventional reactor involves many labor intensive assembly steps. This is because when manufacturing a core for a reactor coil. A large number of transformer plates have to be stapled and cut manually.

Moreover, conventional reactor coils are very heavy indeed. because of the amount of material required for a reactor coil. A typical reactor coil for use in the power distribution network is very heavy indeed, and depending on the required performance and the application a power distribution reactor can weigh several hundreds of kilograms. This is a problem because the material used is expensive, both in terms of transformer plate costs and costs for the copper used for the coil. Another problem is that heavy reactors are cumbersome to move around and install.

Therefore, there exists a need for a reactor core and a reactor that is easy to manufacture and which requires less material than a conventional reactor core and reactor.

### SUMMARY

It is an object of the present invention to overcome or at least reduce some of the problems associated with existing reactor cores and reactor coils.

It is another object of the present invention to provide a reactor core that is easy to manufacture and which is efficient in terms of material need.

It is yet another object of the present invention to provide a reactor core structure that reduces the amount of copper required for the windings of a reactor coil.

These objects and other are obtained by a reactor core and a reactor as set out in the appended claims. Thus, a reactor core is formed in an essentially triangular shape. Such a reactor core shape can advantageously be obtained by winding a strip of electromagnetic material, such as a strip of transformer plate, a number of windings into a triangular shape.

The reactor core being essentially triangularly shaped is then provided with a coil. Advantageously this is performed by cutting the triangular core into three pieces and fitting three pre-wound coils, one on each leg of the triangular core, on the core and then joining the cut legs back together again. Finally the three pre-wound coils are connected to form one common coil mounted on the triangular reactor coil.

The reactor core and reactor in accordance with the invention will provide numerous advantages over existing reactors. To begin with the amount of material required for a reactor in accordance with the invention will be significantly less than the material required for a comparable conventional reactor. This is because there is virtually no losses in the reactor shaped in accordance with the invention. In a conventional reactor there are yokes provided on each side of the reactor coils to close to electromagnetic flow. The yokes will result in losses because they will not contribute to the generation of reactive power. Hence, the material of the yokes will be wasted in terms of providing reactive power.

The reduced amount of electromagnetic material for the core and the reduced amount of copper required for the windings will result in a smaller cost for materials and also to a reactor having lesser weight thereby making it easier to handle.

Moreover, the triangularly shaped core can be manufactured by winding a strip of electromagnetic material, such as transformer plate into the desired shape. This will significantly reduce the cost for manufacturing the core, since no manual stacking of plates is required as is the case for a conventional reactor core.

### BRIEF DESCRIPTION OF THE DRAWINGS

The present invention will now be described in more detail by way of non-limiting examples and with reference to the accompanying drawings, in which:

FIG. 1 is a view of a reactor,

FIG. 2 is a view of a reactor core, and

FIG. 3 is a flow chart illustrating steps performed when manufacturing a reactor coil.

### DETAILED DESCRIPTION

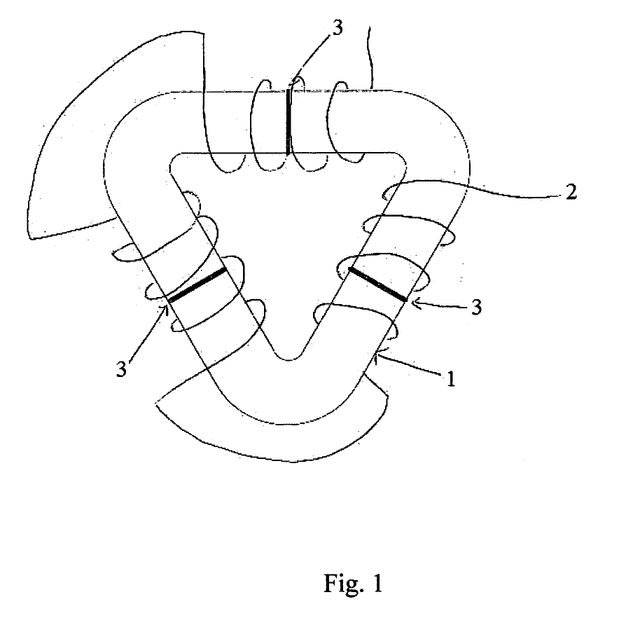

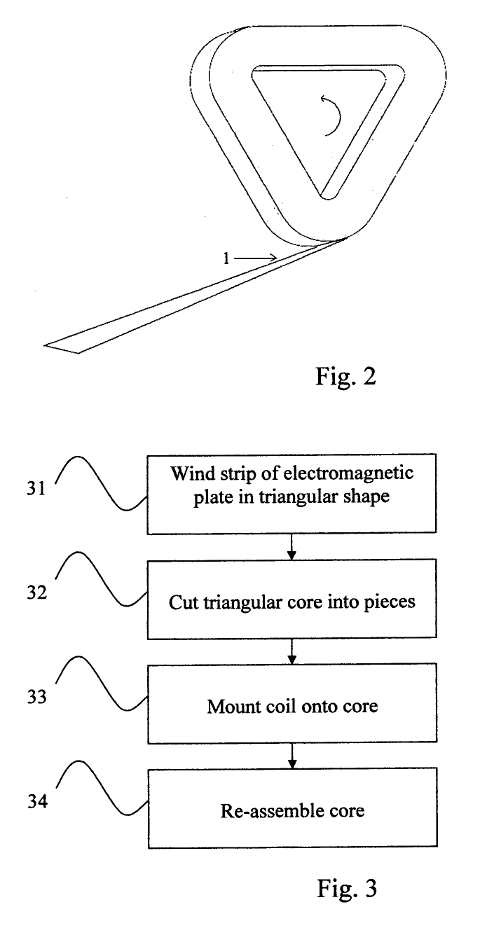

In FIG. 1, a view of a reactor is shown. The reactor comprises a core 1 shaped in an essentially triangular shape and made of an electromagnetic material. In particular the core can be made of thin plate of an electromagnetic material laid in layers to make the core having the desired thickness. In a preferred embodiment the core is made of a single strip of plate wound on triangular frame. This is described in more detail below in conjunction with FIG. 2.

The reactor further comprises a coil 2 of copper wound around the core 1. In a preferred embodiment the coil of copper is formed by three pre-wound coils each fitted on one of the three leg of the triangular core. The reactor further comprises air-gaps 3 provided on each leg of the core 1.

In FIG. 2 a reactor core is shown during manufacturing thereof. Thus, a strip of thin plate of electromagnetic material, such as transformer plate, is wound in an essentially triangular shape in multiple layers. The number of layers will determine the thickness of the core.

In FIG. 3 a flowchart illustrating steps performed when manufacturing a reactor in accordance with the present invention. First in a step 31, a strip of an electromagnetic material such as a strip of transformer plate is wound in multiple layers in an essentially triangular shape and to a desired thickness to form a reactor core having three legs. The core is then cut into pieces, step 32. In a preferred embodiment three cuts are made one at each leg of the triangular core. Thereupon in a step 33, a coil is fitted onto the core. The coil is preferably made out of three pre-wound coils each fitted onto one leg each of the triangular core. Next, in a step 34, the legs of the core are joined with an air-gap having a suitable length for the application of the reactor. Finally, the windings of the coils are joined to form a single coil, if not already joined.

The reactor core and reactor in accordance as described herein will provide numerous advantages over existing reactors. Thus, the amount of material required for a reactor in accordance with the invention will be a fraction of the amount of material for a comparable conventional reactor, since there are virtually no losses in the reactor as described herein.

A reactor in accordance with the invention will require significantly less material than conventional reactors with comparable performance. Typically, a reactor manufactured in accordance with the invention will require less than 60% of the material needed for the most efficient conventional reactors in terms of material use, while maintaining the same or better performance.

The reduced amount of electromagnetic material for the core and the reduced amount of copper required for the windings will result in a smaller cost for materials and also to a reactor having lesser weight thereby making it easier to handle.

Moreover, the triangularly shaped core can be manufactured by winding a strip of electromagnetic material, which will significantly reduce the cost for manufacturing the core, since no manual stacking of plates is required as is the case for a conventional reactor core.

1.-12. (canceled)

13. A reactor for generating reactive power, comprising a core made of an electromagnetic material, and a coil wound around the core, wherein the core has a substantially triangular shape with three legs.

14. The reactor of claim 13, further comprising at least one air-gap located in a cross sectional direction of the core.

15. The reactor of claim 14, wherein an air-gap is located on each leg of the substantially triangularly shaped core.

16. The reactor of claim 13, wherein the core is made of layers of a thin plate.

17. The reactor of claim 16, further comprising at least one air-gap located in a cross sectional direction of the core.

18. The reactor of claim 17, wherein an air-gap is located on each leg of the substantially triangularly shaped core.

19. The reactor of claim 16, wherein the layers of the thin plate are formed from a strip of plate wound in a plurality of layers.

20. The reactor of claim 19, further comprising at least one air-gap located in a cross sectional direction of the core.

21. The reactor of claim 20, wherein an air-gap is located on each leg of the substantially triangularly shaped core.

22. A reactor core made of an electromagnetic material, wherein the core has a substantially triangular shape with three legs.

23. The reactor core of claim 22, further comprising at least one air-gap located in a cross sectional direction of the core.

24. The reactor core of claim 23, wherein an air-gap is located on each leg of the substantially triangularly shaped core.

25. The reactor core of claim 22, wherein the core is made of layers of a thin plate.

26. The reactor core of claim 25, further comprising at least one air-gap located in a cross sectional direction of the core.

27. The reactor core of claim 26, wherein an air-gap is located on each leg of the substantially triangularly shaped core.

28. The reactor core of claim 25, wherein the layers of the thin plate are formed from a strip of plate wound in a plurality of layers.

29. The reactor core of claim 28, further comprising at least one air-gap located in a cross sectional direction of the core.

30. The reactor core of claim 29, wherein an air-gap is located on each leg of the substantially triangularly shaped core.

31. A method of manufacturing a reactor for generation of reactive power, comprising:
winding a strip of electromagnetic material into a core having a substantially triangular shape,
cutting the core into a number of pieces,
fitting a number of pre-wound coils onto the core, and
joining the pieces of the core back into the substantially triangular shape.

32. The method of claim 31, further comprising providing air-gaps at locations of the cuts.
